(19) United States
(12) Patent Application Publication
(10) Pub. No.: US 2018/0306198 A1
(43) Pub. Date: Oct. 25, 2018

(54) TURBOMACHINE WITH AN ADAPTIVE SEALING APPLIANCE

(71) Applicant: Rolls-Royce Deutschland Ltd & Co KG, Blankenfelde-Mahlow (DE)

(72) Inventors: Sebastian MOTSCH, Blankenfelde-Mahlow (DE); Stephan PANNIER, Blankenfelde-Mahlow (DE)

(21) Appl. No.: 15/957,009

(22) Filed: Apr. 19, 2018

(30) Foreign Application Priority Data
Apr. 21, 2017 (DE) 10 2017 108 581.5

(51) Int. Cl. F04D 29/16; F04D 29/58; F04D 29/32; F04D 29/54

(52) U.S. Cl. CPC F04D 29/164; F04D 29/5846; F02K 3/06; F04D 29/542; F04D 29/321

(57) ABSTRACT

A turbomachine, in particular a jet engine of an aircraft, with a rotor device and a stator device, wherein a sealing appliance is arranged preferably in the radial direction between the rotor device and the stator device, with the sealing appliance having a support arm that extends substantially in the axial direction and is connected to the rotor device in a torque-proof manner. The support arm has a sealing lip on the side that faces towards the stator device, and has a covering overlap with an adjoining surface of the rotor device at its inner side. At least one cooling air opening is arranged in the surface of the rotor device in an area of the covering overlap of the support arm of the sealing appliance with the rotor device.

This application claims priority to German Patent Application DE102017108581.5 filed Apr. 21, 2017, the entirety of which is incorporated by reference herein.

The invention relates to a turbomachine, in particular a jet engine of an aircraft, with a rotor device and a stator device, wherein a sealing appliance is arranged between the rotor device and the stator device, according to the kind as it is defined more closely in the generic term of patent claim 1.

What is known from DE 10 2011 014 292 A1 is a gas turbine engine in which appliance a sealing appliance is arranged in the radial direction between a stator appliance and a rotor, with the sealing appliance being connected in a torque-proof manner to the rotor appliance. The sealing appliance has a support arm and sealing lips on a side of the support arm that faces the stator appliance. In a radially inner area, the stator appliance is embodied with a running-in layer that is provided for acting together with the sealing appliance. The support arm with the sealing lips has a free end that can move in the radial direction towards the stator appliance during operation, for example due to movements and/or thermal expansions of the rotor appliance and/or an internal stress of the sealing appliance which is reduced depending on the temperature.

In practice, a design of the sealing appliance and of an air gap with respect to the stator device is performed based on the respectively present frame conditions, and is limited by the temperatures and stresses in the area of the sealing appliance, as they are present during operation.

In order to reduce an undesirably strong contact of the rotating sealing appliance with the running-in layer, either a sufficient static design of the air gap or also an active gap positioning by controlled movements of the stator or a controlled deformation of the housing is realized on the side of the stator device.

One known measure for decreasing the contact between the sealing lips of the sealing appliance and a stator is to design relatively large gaps, wherein this undesirably leads to unwanted air system losses independently of the operational state.

An alternative measure is a run-in coating of the sealing lip for minimizing abrasion to the sealing lip and/or the running-in layer of the stator appliance at a relatively small gap size, and thus prolong the service life of the components and the maintenance intervals. However, here one disadvantage is that the manufacture, maintenance, repair and operation of the sealing appliance are elaborate and expensive.

In addition, in practice a design is also realized with a view to service intervals. However, here a short service life of the sealing appliance has to be accepted.

A further possibility of gap positioning with respect to the stator is to realize the sealing appliance in an especially solid design and in this manner achieve a decrease in the stress level of the sealing appliance and reduce its deformation during operation. However, such sealing appliances have a disadvantageously high weight.

The invention is based on the objective of creating a turbomachine of the kind as it is described more closely above, and namely in such a manner that during operation a sealing appliance fixed to the rotor takes a position with respect to a stator device in which air system losses are minimized, wherein the sealing appliance can be realized in a simple and low-maintenance manner as well as with a low mass.

According to the invention, the objective is achieved by a turbomachine embodied according to the features of patent claim 1.

What is proposed is a turbomachine, in particular a jet engine of an aircraft, with a rotor device and a stator device, wherein a sealing appliance is arranged preferably in the radial direction between the rotor device and the stator device, with the sealing appliance having a support arm that extends substantially in the axial direction and is connected in a torque-proof manner to the rotor device. The support arm has a sealing lip on the side that is facing the stator device, and on its radially inner side has a covering overlap with an adjoining surface of the rotor device.

According to the invention, it is provided that at least one cooling air opening is arranged in an area of the covering overlap of the support arm of the sealing appliance with the rotor device in the surface of the rotor device.

The solution according to the invention provides a seal in which a so-called air gap between the sealing appliance and the stator device can be set and maintained to be small in a simple and cost-effective manner, so that an air flow that is guided during operation in the axial direction through the gap is very small and an efficient sealing behavior is obtained with an accompanying high degree of efficiency.

This is achieved by reducing heating and possibly deformation of the sealing appliance as caused by operating loads by means of an active cooling. By providing the cooling air opening, the sealing appliance that is firmly connected to the rotor device is impinged directly with cooling air during operation, so that an undesirably strong heating of the sealing appliance is prevented also at high operating temperatures, and the occurring temperatures are reduced as compared to known solutions. In this manner, a stress load and deformation of the sealing appliance is advantageously reduced during operation, so that the sealing appliance has a comparatively high service life even without a run-in coating being provided.

With the invention, the sealing appliance can also be embodied so as to be advantageously small and light, wherein reductions in stiffness that occur as a result are compensated by the cooling of the sealing appliance. The possible reduction in material thickness and mass can lead to sealing appliances and/or support arms that are particularly structurally flexible or thin, and that may also be arranged on small, separate attachment parts.

Further, in the solution according to the invention, the operational safety is increased, since a loading of the sealing appliance is reduced by the cooling. Even a failure of the sealing appliance, which can be determined with known means such as e.g. by detecting vibrations resulting from an imbalance and for which there is a considerably lower probability than in known embodiments, would have only a small impact on the behavior of the total system of the turbomachine, since, due to the low mass of the sealing appliance, there are no parts that can be released with high energy in the case of a failure.

In an advantageous embodiment of a turbomachine according to the invention, the surface of the rotor device forms at least one support area for the support arm in the area of the covering overlap with the support arm of the sealing appliance. In this manner, an advantageous support of the sealing appliance at the rotor device is created, wherein the support arm rests on the rotor device at least in certain areas, in particular at its area that faces away from the free end, in all operational states.

An advantageous support of the sealing appliance at the rotor device, in particular in the basic position of the sealing appliance, is created if the surface of the rotor device forms two support areas for the support arm that are arranged at a distance from each other in the axial direction in the area of the covering overlap with the support arm of the sealing appliance, wherein at least one cooling air opening is arranged in the axial direction between the support areas.

In an advantageous further development of the invention, a cooling air channel or annular channel extending about the circumferential direction is formed between the support arm and the adjoining surface of the rotor device between the axially spaced-apart support areas, with the at least one cooling air opening that opens into the cooling air channel or annular channel. In this manner, the sealing appliance or its support arm can be supplied with cooling air in all operational states across its entire a circumference.

In order to achieve a sufficient cooling of the sealing appliance, in an advantageous embodiment the rotor device has multiple cooling air openings which are distributed in the circumferential direction and which can for example be arranged so as to be evenly distributed in the circumferential direction and be formed in a circular or slit-shaped manner.

The number and size of the cooling air openings is preferably chosen in such a manner that a thermally caused maximal radial movement of the support arm of the sealing appliance in the direction of the stator device is limited to a pre-defined measure during operation. At that, the lifting off of a free end of the support arm and thus the opening of a cooling air passage from the confluence area of the cooling air bores can represent an intended thermally induced movement as a part of the active cooling of the sealing appliance.

The sealing appliance can advantageously be manufactured in a simple manner if the sealing appliance represents a separate structural component that is connected by suitable attachment means, e.g. a flange crew connection, to the rotor device. For example, the sealing appliance can be arranged between cantilevers, so-called drive arms, of two rotors of the rotor device that are arranged axially behind one another.

Alternatively, it can also be provided that the sealing appliance is embodied integrally with a structural component of the rotor device, in particular of a cantilever or drive arm between two disc wheels that are placed axially behind one another or a plate of a rotor device.

The features specified in the patent claims as well as the features specified in the following exemplary embodiments of the turbomachine according to the invention are suitable to further develop the subject matter according to the invention respectively on their own or in any desired combination with each other.

Further advantages and advantageous embodiments of the turbomachine according to the invention become apparent from the patent claims and from the exemplary embodiments described in principle in the following by referring to the drawing, wherein, with a view to clarity, the same reference signs are used in the description of the exemplary embodiments for structural components having the same structure and functionality.

Here:

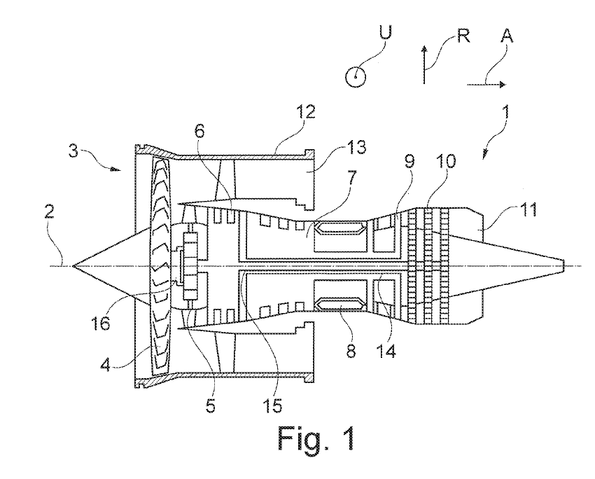

FIG. 1 shows a simplified sectional view of a jet engine with a fan, a compressor appliance, a burner and a turbine appliance;

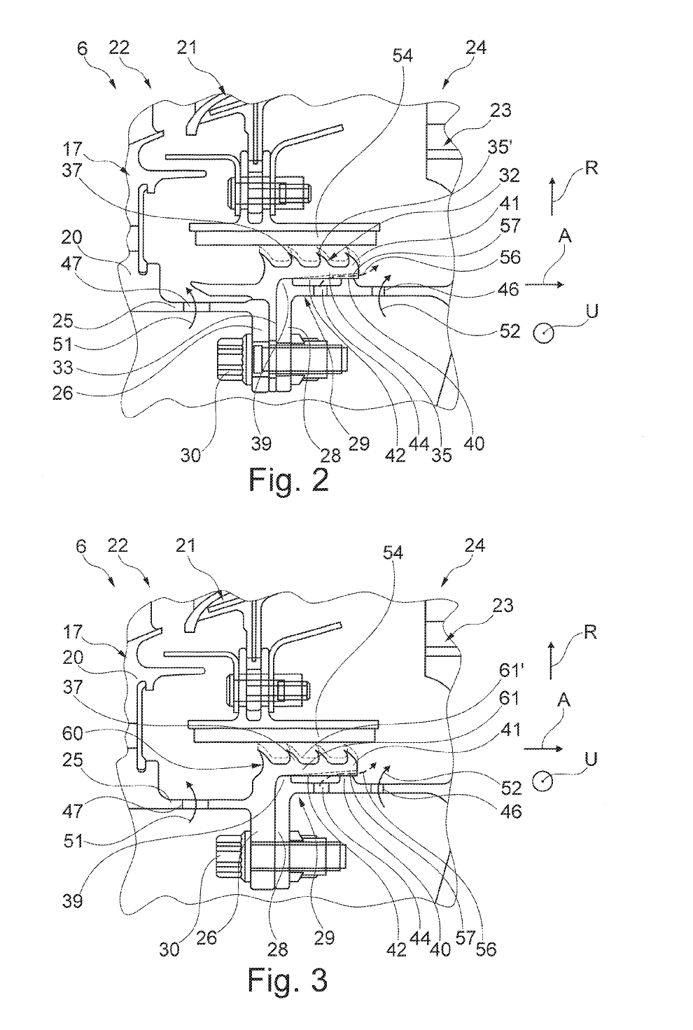

FIG. 2 shows a strongly schematized illustration of an area of the compressor appliance of the jet engine according to FIG. 1, wherein a rotor device, a stator device, and a first embodiment of a sealing appliance can be seen; and

FIG. 3 shows an area of the compressor appliance according to FIG. 1 which corresponds to FIG. 2, with a second embodiment of a sealing appliance.

FIG. 1 shows a turbomachine that is embodied as a jet engine 1 of an aircraft. The jet engine 1 has a main axis and rotational axis 2. Further, the jet engine 1 comprises in the axial flow direction an air intake 3, a fan 4, a planetary gear 5, an intermediate-pressure compressor 6, a high-pressure compressor 7, a combustion appliance 8, a high-pressure turbine 9, a low-pressure turbine 10 and a discharge nozzle 11. An engine nacelle 12 surrounds the jet engine 1 and delimits the intake 3.

The jet engine 1 operates in a conventional manner, wherein air entering the intake 3 is accelerated by the fan 4 to create two air flows. A first air flow flows into the intermediate-pressure compressor 6 and a second air flow is passed through a bypass channel 13 to provide a drive thrust. The intermediate-pressure compressor 6 compresses the air flow that is supplied to it, before the air is further compressed in the area of the high-pressure compressor 7.

The compressed air that is discharged from the high-pressure compressor 7 is introduced into the combustion appliance 8, where an intermixing with fuel occurs, and the fuel-air mixture is combusted. The resulting hot combustion products expand and in doing so drive the high-pressure turbine 9 and the low-pressure turbine 10, before they are discharged via the discharge nozzle 11 to provide additional drive thrust. The high-pressure turbine 9 and the low-pressure turbine 10 drive the high-pressure compressor 7 or the intermediate-pressure compressor 6 by means of a high-pressure shaft 14 or a low-pressure shaft 15. The low-pressure shaft 15 that couples the low-pressure turbine 10 with the intermediate-pressure compressor 6 drives the fan 4 via the planetary gear 5, wherein a drive torque that is applied to the planetary gear 5 via the low-pressure shaft 15 is increased corresponding to the stationary gear ratio of the planetary gear 5, and is supplied to a fan shaft 16, while the rotational speed of the low-pressure shaft 15 is greater by the factor of the stationary gear ratio of the planetary gear 5 than the rotational speed of the fan shaft 16. If the fan 4 is driven by the low-pressure turbine 10, the rotational speed of the low-pressure shaft 15 is reduced corresponding to the gear ratio of the planetary gear 5 in the area of the planetary gear 5, and the fan shaft 16 as well as the fan 4 are driven with this reduced rotational speed and with a torque that is increased with respect to the torque applied to the low-pressure shaft 15.

FIG. 2 and FIG. 3 show a section of the intermediate-pressure compressor 6, wherein a stator device 21 and a rotor device 17 with a first rotor or blade wheel 20 of a stage 22 of the intermediate-pressure compressor 6 and with an axially downstream second rotor 23 of a further stage 24 of the intermediate-pressure compressor 6 can be seen in more detail. The rotor 20 has a cantilever or drive arm 25 that substantially extends in the axial direction A of the jet engine 1 and is part of a tubular section of the rotor device 17. Connecting to the cantilever 25 in an area that faces towards the second rotor 23 is a flange 26 that extends substantially in the radial direction R of the jet engine 1 and forms a circular disc-shaped area of the rotor 20. In an area that faces towards the first rotor 20, the second rotor 23 has a leg or flange 28 that extends substantially in the radial direction R and forms a circular disc-shaped area and is connected to a cantilever or drive arm 29 of the second rotor 23 that extends substantially in the axial direction. In the shown embodiment, the cantilevers and flanges 25, 26, 28, 29 are embodied in particular in a sheet-metal-like manner with a substantially constant wall thickness.

The rotors 20, 23 are connected to each other in the area of the flanges 26, 28 by means of a screw connection 30, wherein, in the embodiment shown in FIG. 2, a leg or flange 33 of a sealing appliance 32 extending substantially in the radial direction R is arranged between the flanges 26, 28 in the axial direction A.

In the longitudinal section, the sealing appliance 32 is embodied with an angular profile that comprises the flange 33 in the radial direction R and an axial leg 35 that in the present case extends downstream of the flange 33.

The downstream leg 35 forms a support arm that axially overlaps an area of the cantilever 29 of the second rotor 23 and has a sealing lip 37 with multiple sealing tips on the side that faces away from the rotor device 17 and thus the side that faces towards the stator device 21.

In the present case, the cantilever 29 of the rotor 23 has two support areas 39, 40 at which the support arm 35 rests in a basic position of the sealing appliance 32, which the sealing appliance 32 takes in the absence of operating loads. The support areas 39, 40 are arranged at a distance with respect to each other in the axial direction A, wherein a first support area 39 acts together with an area of the support arm 35 that is facing towards the flange 33 and here is arranged substantially in the area of the flange 28 of the rotor 23, as viewed in the axial direction A. The second support area 40 of the rotor device 17 serves as a contact surface for an axially downstream free end area 41 of the support arm 35.

In the axial direction A between the first support area 39 and the second support area 40, the support arm 35 is arranged at a distance from the covered surface of the rotor device 17 or the cantilever 29 of the rotor 23 in the radial direction R in the basic position of the sealing appliance 32, so that an annular channel or cooling air channel 42 is formed in this manner, which in the present case extends about the entire circumferential direction U. Opening into the annular channel 42 is/are one or multiple cooling air openings 44 that pass through the cantilever 29 in the radial direction R. Provided in the present case is a plurality of cooling air openings 44 which are arranged so as to be evenly distributed in the circumferential direction U.

Thus, the cooling air openings 44 are arranged in an area of the cantilever 29 of the rotor 23, as viewed in the axial direction A, where also the support arm 35 of the sealing appliance 32 is arranged, so that cooling air that is guided through the cooling air opening 44 during operation directly impinges on the sealing appliance 32.

In addition to the cooling air openings 44, the cantilever 29 of the rotor 23 has further cooling air openings 46 that pass through the cantilever 29 in the radial direction R and are arranged in the axial direction A downstream of the sealing appliance 32, and thus are no longer located in the covering overlap area of the sealing appliance 32 and the rotor device 17.

In addition, the cantilever 25 of the upstream rotor 20 has a plurality of cooling air openings 47 that are arranged so as to be distributed in the circumferential direction U. Thus, during operation of the jet engine 1, cooling air also flows through these cooling air openings 46 and 47 according to the arrows 51, 52 into a space surrounding the sealing appliance 32.

During operation of the jet engine 1, high temperatures are present in the area of the sealing appliance 32 and the sealing appliance 32 is subject to strong centrifugal forces, in particular at the support arm 35, so that if necessary the support arm 35 can be shifted into a position 35′, which is shown by a dashed line in a simplified manner, depending on the operational state, wherein in the position 35′ the end area 41 of the support arm 35 is arranged at a distance to the downstream support area 40 at the rotor surface, and the sealing lips 32 can come into abutment with a running-in layer 54 of the stator device 21.

The thermally dominated deformation of the support arm 35 caused by operating loads can be reduced and set in a targeted manner by means of the active rotor-side cooling, in which cooling air travels through the cooling air openings 44 into the annular channel 42 for cooling the support arm 35.

For example, during a start of an aircraft that is embodied with the jet engine 1, in a so-called take-off operational state, forces and temperatures can act on the support arm 35, as a result of which the latter is displaced in to the position 35′ as indicated by dashed lines. In the event of such a displacement of the support arm 35 and its lifting from its rotor-side bearing surface, the annular channel 42 is opened towards its environment, so that cooling air is guided from the annular channel 42 through a cooling air passage 57 into the surrounding space according to the arrow 56, and an additional cooling air flow for cooling the sealing appliance 32 is present.

By providing the cooling air openings 44, a gap that is present in the basic position of the sealing appliance 32 in the radial direction R between the sealing lips 37 and the running-in layer 54 of the stator device 21 can be chosen to be advantageously small, wherein the sealing appliance 32 or the support arm 35 can be realized with a smaller material thickness and with a low thermal inertia in the radial direction R.

FIG. 3 shows a further embodiment of a sealing appliance 60, wherein in the following only the differences to the sealing appliance 32 are discussed, and otherwise the above embodiments are referred to.

The sealing appliance 60 is embodied integrally with the rotor device 17, here with the cantilever 25 of the upstream-side rotor 20, wherein the rotors 20, 23 are directly connected to each other via the screw connection 30 in the area of the flanges 26 and 28, so that the flanges 26, 28 of the rotors 20, 23 rest directly against each other. The sealing appliance 60 again has a support arm 61, which is embodied with a sealing lip 37, in a manner substantially comparable to the support arm 35.

In alternative embodiments of the invention, the sealing appliance can also be arranged in the area of a high-pressure compressor or in the area of a turbine, in particular a low-pressure turbine or a high-pressure turbine.

### PARTS LIST

1 turbomachine; jet engine
2 main rotational axis
3 air intake
4 fan
5 planetary gear
6 intermediate-pressure compressor
7 high-pressure compressor
8 combustion appliance
9 high-pressure turbine
10 low-pressure turbine
11 discharge nozzle
12 engine nacelle
13 bypass channel
14 high-pressure shaft
15 low-pressure shaft
16 fan shaft
17 rotor device
20 rotor
21 stator device
22 stage
23 rotor
24 further stage
25 cantilever of the rotor device (drive arm)
26 flange of the rotor device
28 flange of the rotor device
29 cantilever of the rotor device (drive arm)
30 screw connection
32 sealing appliance
33 flange of the sealing appliance
35 leg of the sealing appliance; support arm
37 sealing lip
39 first support area
40 second support area
41 end area of the support arm
42 annular channel
44 cooling air opening
46 cooling air opening
47 cooling air opening
51, 52 arrow
54 running-in layer
56 arrow
57 cooling air passage
60 sealing appliance
61 support arm
A axial direction
R radial direction
U circumferential direction

1. Turbomachine, in particular jet engine of an aircraft, with a rotor device and a stator device, wherein a sealing appliance is arranged between the rotor device and the stator device, having a support arm that extends substantially in the axial direction and is connected to the rotor device in a torque-proof manner, and comprises a sealing lip on the side that is facing towards the stator device and a covering overlap with an adjoining surface of the rotor device at its inner side, wherein at least one cooling air opening is arranged in an area of the covering overlap of the support arm of the sealing appliance with the rotor device in the surface of the rotor device.

2. The turbomachine according to claim 1, wherein the surface of the rotor device forms at least one support area for the support arm in the area of the covering overlap with the support arm of the sealing appliance.

3. The turbomachine according to claim 2, wherein, in the area of the covering overlap with the support arm of the sealing appliance, the surface of the rotor device forms two support areas for the support arm that are arranged at a distance from each other in the axial direction, wherein at least one cooling air opening is arranged in the axial direction between the support areas.

4. The turbomachine according to claim 3, wherein, between the support areas that are arranged at an axial distance to each other, a cooling air channel that extends about the circumferential direction is formed between the support arm and the adjoining surface of the rotor device, with the at least one cooling air that opens into it.

5. The turbomachine according to claim 1, wherein the rotor device has multiple cooling air openings distributed in the circumferential direction.

6. The turbomachine according to claim 1, wherein the number and size of the cooling air openings is chosen in such a manner that a thermally caused maximal radial movement of the support arm of the sealing appliance is limited to a pre-defined measure in the direction of the stator device during operation.

7. The turbomachine according to claim 1, wherein the sealing appliance is a separate structural component.

8. The turbomachine according to claim 7, wherein the sealing appliance is arranged between cantilevers (drive arms) of two rotors of the rotor device that are arranged axially behind each other.

9. The turbomachine according to claim 1, wherein the sealing appliance is embodied integrally with a structural component of the rotor device.
